(19) United States
(12) Patent Application Publication
(10) Pub. No.: US 2025/0377769 A1
(43) Pub. Date: Dec. 11, 2025

(54) USER EMOTION FEEDBACK METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Sha SHA, Shenzhen (CN); Yang ZENG, Shenzhen (CN); Liqiang LIU, Shenzhen (CN); Xianmin XIAO, Shenzhen (CN)

(73) Assignee: TENCENT TECHNOLOGY (SHENZHEN) COMPANY LIMITED, Shenzhen (CN)

(21) Appl. No.: 19/302,245

(22) Filed: Aug. 18, 2025

Related U.S. Application Data
(63) Continuation of application No. PCT/CN2024/110266, filed on Aug. 7, 2024.

(30) Foreign Application Priority Data
Aug. 9, 2023 (CN) 202311001427.9

(51) Int. Cl. G06F 3/0484

(52) U.S. Cl. CPC G06F 3/0484

(57) ABSTRACT

A user emotion feedback method, apparatus, and computer-readable storage medium for expressing emotions in social circle interactions through virtual figures. The method displays a first user interface containing a social circle message posted by a second account on a first client logged in with a first account. Based on a trigger operation on a user feedback control for the social circle message, feedback information of the first account's user emotion is displayed through a first virtual figure corresponding to the first account. The user feedback control is configured to provide emotion feedback on social circle messages, enabling expressive and personalized emotional responses through virtual figure representations.

### CROSS-REFERENCE TO RELATED APPLICATIONS

This application is a continuation application of International Application No. PCT/CN2024/110266 filed on Aug. 7, 2024 which claims priority to Chinese Patent Application No. 202311001427.9, filed with the China National Intellectual Property Administration on Aug. 9, 2023, the disclosures of each being incorporated by reference herein in their entireties.

### FIELD

The disclosure relates to the field of human-computer interaction, a user emotion feedback method and apparatus, a computer device, and a storage medium.

### BACKGROUND

When browsing social circle messages on an electronic social platform, a user may provide emotion feedback on the social circle messages, for example, like, share, send a sticker, and add favorites.

In some methods, an example in which the user emotion feedback is like may be used. A like control for a social circle message and a quantity of likes for the social circle message or a name of a user account that likes the social circle message is displayed on a user interface. After the user likes the social circle message, the like control on the user interface may be highlighted.

### SUMMARY

Provided are a user emotion feedback method and apparatus, a device, a storage medium, and a program product, which can implement intuitive emotion expression through virtual figure-based feedback in social circle interactions.

According to some embodiments, a user emotion feedback method, performed by a computer device, includes: displaying, by a first client logged in with a first account, a first user interface comprising a first social circle message posted by a second account; and displaying, by the first client, feedback information of a user emotion of the first account for the first social circle message through a first virtual figure, based on a trigger operation on a user feedback control for the first social circle message, wherein the first virtual figure corresponds to the first account, and the user feedback control is configured to provide emotion feedback on the first social circle message.

According to some embodiments, a user emotion feedback apparatus, includes: at least one memory configured to store program code; and at least one processor configured to read the program code and operate as instructed by the program code, the program code including: interface code configured to cause at least one of the at least one processor to display, by a first client logged in with a first account, a first user interface comprising a first social circle message posted by a second account; and feedback code configured to cause at least one of the at least one processor to display, by the first client, feedback information of a user emotion of the first account for the first social circle message through a first virtual figure, based on a trigger operation on a user feedback control for the first social circle message, wherein the first virtual figure corresponds to the first account, and the user feedback control is configured to provide emotion feedback on the first social circle message.

According to some embodiments, a non-transitory computer-readable storage medium, storing computer code which, when executed by at least one processor, causes the at least one processor to at least: display, by a first client logged in with a first account, a first user interface comprising a first social circle message posted by a second account; and display, by the first client, feedback information of a user emotion of the first account for the first social circle message through a first virtual figure, based on a trigger operation on a user feedback control for the first social circle message, wherein the first virtual figure corresponds to the first account, and the user feedback control is configured to provide emotion feedback on the first social circle message.

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of a user emotion feedback method in some methods.

FIG. 2 is a schematic diagram of a user emotion feedback method in some methods.

FIG. 3 is a schematic diagram of a user emotion feedback method according to some embodiments.

FIG. 4 is a schematic diagram of a user emotion feedback method according to some embodiments.

FIG. 5 is a schematic diagram of an interface for setting an online state according to some embodiments.

FIG. 6 is a schematic diagram of a user emotion feedback method according to some embodiments.

FIG. 7 is a block diagram of a structure of a computer system according to some embodiments.

FIG. 8 is a flowchart of a user emotion feedback method according to some embodiments.

FIG. 9 is a schematic diagram of emotion stickers according to some embodiments.

FIG. 10 is a flowchart of a user emotion feedback method according to some embodiments.

FIG. 11 is a flowchart of obtaining an emotion sticker according to some embodiments.

FIG. 12 is a flowchart of a user emotion feedback method according to some embodiments.

FIG. 13 is a flowchart of a user emotion feedback method according to some embodiments.

FIG. 14 is a flowchart of a user emotion feedback method according to some embodiments.

FIG. 15 is a flowchart of a user emotion feedback method according to some embodiments.

FIG. 16 is a flowchart of dynamic data structures according to some embodiments.

FIG. 17 is a flowchart of a user emotion feedback method according to some embodiments.

FIG. 18 is a block diagram of a structure of a user emotion feedback apparatus according to some embodiments.

FIG. 19 is a block diagram of a structure of a user emotion feedback apparatus according to some embodiments.

FIG. 20 is a block diagram of a structure of a user emotion feedback apparatus according to some embodiments.

FIG. 21 is a block diagram of a terminal according to some embodiments.

FIG. 22 is a block diagram of a server according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Terms in this application are explained first.

User feedback control: The user feedback control is a control configured for providing emotion feedback on a social circle message. The emotion feedback means expressing feelings or emotions of a user on the social circle message. The user feedback control for the social circle message includes controls named “Like”, “Boost”, “Favorite”, and the like. Generally, the user feedback control only may be triggered, and does not require text input.

Virtual figure: The virtual figure is a figure created or selected by a user for representing the user in a virtual social environment, to implement interaction and communication between users. The virtual figure is presented by using a plurality of media elements such as an image, an animation, and a sound, and can be personalized and customized by the user. The virtual figure may be a two-dimensional figure, a two-and-a-half-dimensional figure, or a three-dimensional figure.

Social circle: The social circle is a virtual social network, and includes an individual user and social relationships between the individual user and friends, families, and colleagues that have connections on a social platform. The user can share information, perform interaction and communication, update statuses, and view posts in a digital environment through functions and features of an application, to construct and maintain social connections and connection networks of the user.

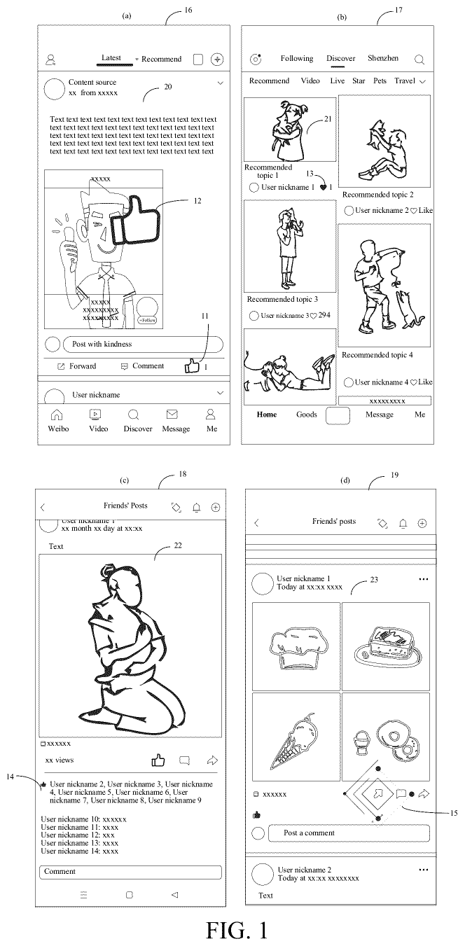

FIG. 1 is a schematic diagram of a method for a user to provide user emotion feedback on a social circle message in some methods. A first social circle message 20 is displayed on a user interface 16 in FIG. 1(a), and user emotion feedback is provided by clicking/tapping a user feedback control 11 for the first social circle message 20. Generally, the user feedback control only may be triggered, and does not require text input. After the user triggers the user feedback control 11, feedback information 12 of a user emotion, for example, enlarged thumbs up, is displayed on the user interface 16. A first social circle message 21 is displayed on a user interface 17 in FIG. 1(b), and user emotion feedback is provided by clicking/tapping a user feedback control 13 for the first social circle message 21. After the user triggers the user feedback control 13, the user feedback control 13, for example, a heart icon in the figure, is highlighted on the user interface 17. A first social circle message 22 is displayed on a user interface 18 in FIG. 1(c). The user may see, on the user interface 18, a user account 14 that has provided user emotion feedback on the first social circle message 22. A first social circle message 23 is displayed on a user interface 19 in FIG. 1(d), and user emotion feedback is provided by clicking/tapping a user feedback control 15 for the first social circle message 23. After the user triggers the user feedback control 15, the user feedback control 15 displayed on the user interface 19 changes into another icon of a user emotion, in other words, the user feedback control changes into another icon to provide feedback information of a user emotion for the user.

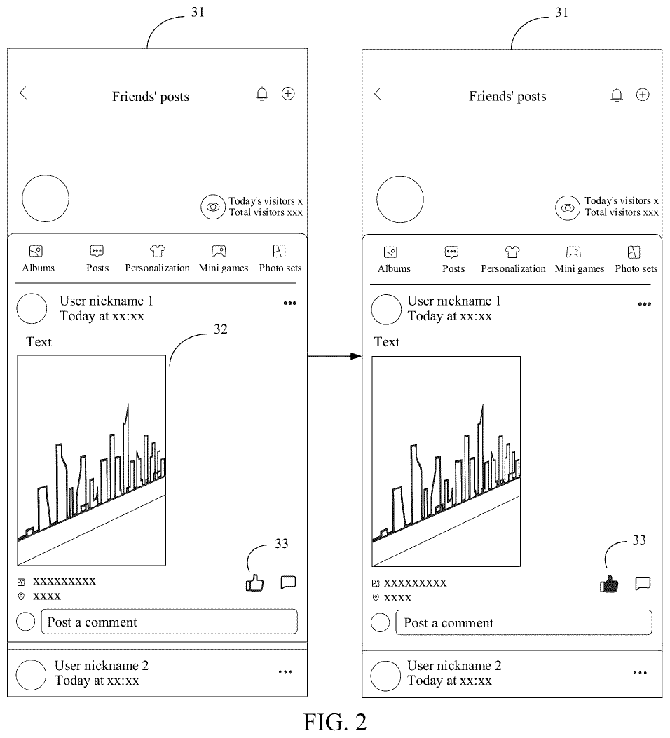

FIG. 2 is also a schematic diagram of a method for a user to provide user emotion feedback on a social circle message in some methods. A first social circle message 32 is displayed on a user interface 31 in FIG. 2, and user emotion feedback is provided by clicking/tapping a user feedback control 33 for the first social circle message 32. After the user triggers the user feedback control 33, the user feedback control 33 is filled or highlighted on the user interface 31.

It can be learned from the methods for a user to provide user emotion feedback on a social circle message that are shown in FIG. 1 and FIG. 2, all feedback information of a user emotion for a social circle message is consistent. In some embodiments, there are only several simple and fixed icon changes, and a publisher of a social circle message often finds it difficult to distinguish identities of feedback providers. Consequently, a manner of feeding back a user emotion is very simple, and efficiency of human-computer interaction is low. Therefore, how to achieve a better user emotion feedback effect is a problem that may be resolved.

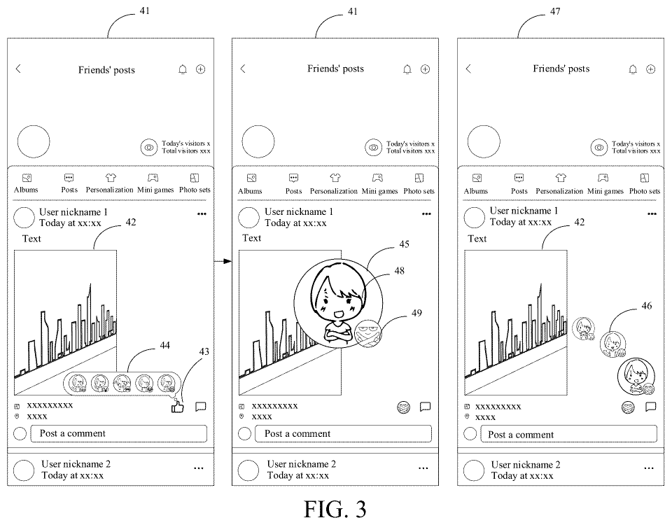

According to a method provided in some embodiments, after a user feedback control for a social circle message is triggered, feedback information of a user emotion is displayed through a virtual figure corresponding to a user account, so that the user emotion can be more reflected, manners of feeding back the user emotion are diversified, and interests of user emotion feedback are increased. Therefore, a publisher of the social circle message can learn of a user account who provides feedback, thereby improving human-computer interaction efficiency. FIG. 3 to FIG. 6 are schematic diagrams of user emotion feedback methods according to this application.

As shown in FIG. 3, a first social circle message 42 posted by a second account and a user feedback control 43 for the first social circle message 42 are displayed on a user interface 41 of a first account. After a user using the first account touches and holds the user feedback control 43, a plurality of candidate figurea 44 are displayed on the user interface 41 of the first account. The user selects a target figure of the plurality of candidate figures 44, and the target figure 45 is enlarged and displayed on the user interface 41 of the first account. The target figure 45 includes a first virtual figure 48 and an emotion sticker 49. When a user using the second account views the first social circle message 42 of the user, the first social circle message 42 is displayed on a user interface 47 of the second account, and all target figures 46 corresponding to user accounts that provide feedback on the first social circle message 42 are displayed in a scrolling manner. For example, all the target figures 46 corresponding to the user accounts that provide feedback on the first social circle message 42 are displayed in a scrolling manner like bullet comments. In some embodiments, all the target figures 46 corresponding to the user accounts that provide feedback on the first social circle message 42 are displayed in a scrolling manner like floating bubbles. The first virtual figure is a virtual figure corresponding to the first account.

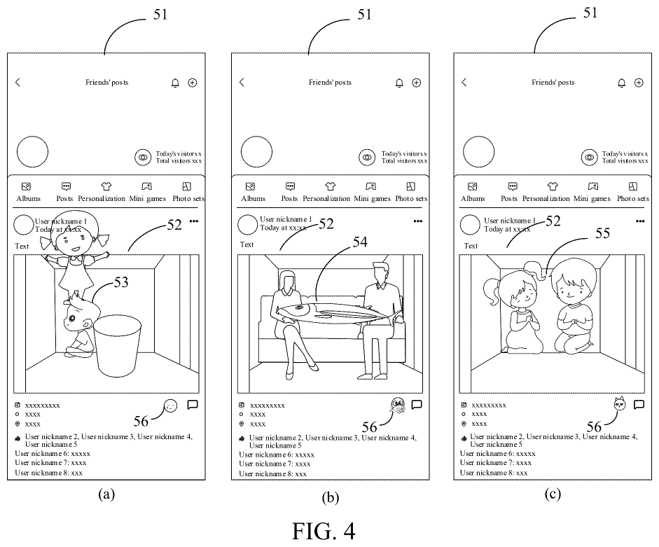

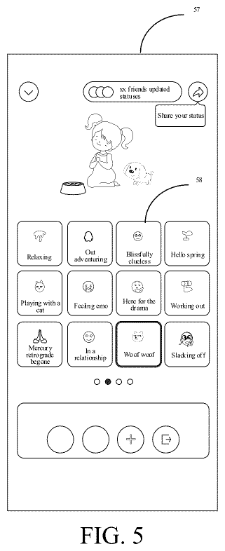

As shown in FIG. 4, a first social circle message 52 posted by a second account and a user feedback control 56 for the first social circle message 52 are displayed on a user interface 51 of a first account.′ As shown in FIG. 4(a), the second account is online and an online state of “lost” (for example, a sad state) is set. After the first account short clicks/taps the user feedback control 56, feedback information 53 corresponding to a sad emotion is displayed on the user interface 51 of the first account. The feedback information 53 is a first virtual figure and a second virtual figure that have an encouraging emotion. As shown in FIG. 4(b), the second account is online and an online state of “leisure” (for example, a leisure state) is set. After the first account short clicks/taps the user feedback control 56, feedback information 54 corresponding to the leisure state is displayed on the user interface 51 of the first account. The feedback information 54 includes a first virtual figure and a second virtual figure that have a relaxed emotion. As shown in FIG. 4(c), the second account is online and an online state of “hardworking” (for example, a hardworking state) is set. After the first account short clicks/taps the user feedback control 56, feedback information 55 corresponding to the hardworking state is displayed on the user interface 51 of the first account. The feedback information 55 includes a first virtual figure and a virtual figure of the second account that have a focused emotion. The first virtual figure is a virtual figure corresponding to the first account, and the second virtual figure is a virtual figure corresponding to the second account. FIG. 5 is a schematic diagram of modifying an online state. As shown in the figure, a plurality of online states 58, such as “Working out” and “In a relationship”, are displayed on an online state modification interface 57. Different online states correspond to different feedback information.

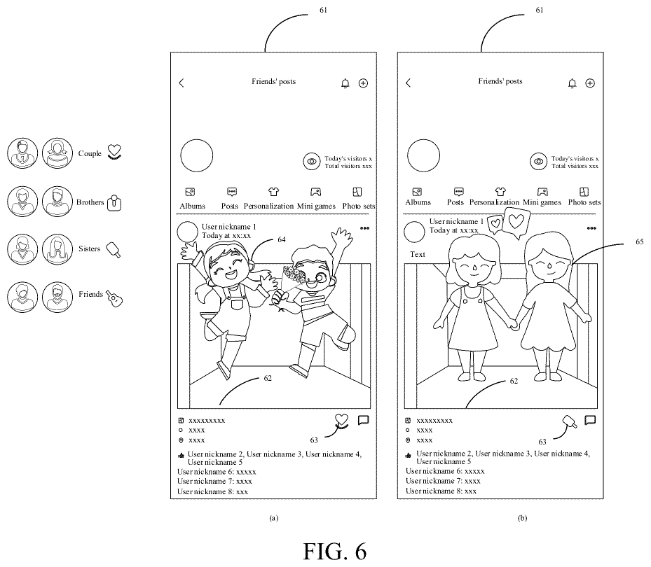

As shown in FIG. 6, a first social circle message 62 posted by a second account and a user feedback control 63 for the first social circle message 62 are displayed on a user interface 61 of a first account. As shown in FIG. 6(a), the first account and the second account have an intimate relationship as a couple. After the first account clicks/taps the user feedback control 63, feedback information 64 is displayed on the user interface 61 of the first account. The feedback information 64 includes a first virtual figure and a second virtual figure that have a loving emotion. As shown in FIG. 6(b), the first account and the second account have an intimate relationship as sisters. After the user using the first account clicks/taps the user feedback control 63, feedback information 65 is displayed on the user interface 61 of the first account. The feedback information 65 includes a first virtual figure and a second virtual figure that have a shy emotion.

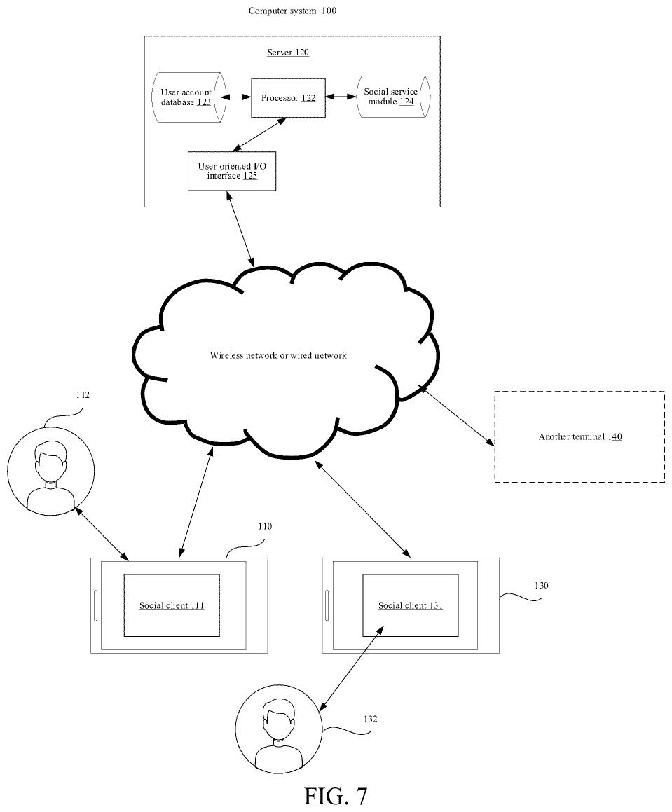

FIG. 7 is a block diagram of a structure of a computer system according to some embodiments. The computer system 100 includes: a first terminal 110, a server 120, and a second terminal 130.

A first client 111 that supports a social function is installed and run on the first terminal 110. The first client 111 may be an application or a web client that has the social function. When the first terminal 110 runs the first client 111, a user interface of the first client 111 is displayed on a screen of the first terminal 110. The application may be any one of a WeChat application, a Weibo application, a network community application, a payment application, a shopping application, a dating application, and a matchmaking application. In some embodiments, an example in which the application is a social application is used for description. The first terminal 110 is a terminal used by a first user 112, and a first user account of the first user 112 is logged in on the first client 111.

A second client 131 that supports a social function is installed and run on the second terminal 130. The second client 131 may be an application or a web client that has the social function. When the second terminal 130 runs the second client 131, a user interface of the second client 131 is displayed on a screen of the second terminal 130. The application may be any one of an instant messaging application, a Weibo application, a network community application, a payment application, a shopping application, a dating application, and a matchmaking application. In some embodiments, an example in which the application is a social application is used for description. The second terminal 130 is a terminal used by a second user 132, and a second user account of the second user 132 is logged in on the second client 131.

In some embodiments, applications installed on the first terminal 110 and the second terminal 130 are the same, or applications installed on the two terminals are a same type of applications on different operating system platforms (Android system or IOS system). The first terminal 110 may generally be one of a plurality of terminals, and the second terminal 130 may generally be another one of the plurality of terminals. In some embodiments, only the first terminal 110 and the second terminal 130 are used as examples for description. Device types of the first terminal 110 and the second terminal 130 are the same or different. The device type includes: at least one of a smart phone, a tablet, an e-book reader, a Moving Picture Experts Group Audio Layer III (MP3) player, a Moving Picture Experts Group Audio Layer IV (MP4) player, a portable laptop computer, and a desktop computer.

FIG. 7 only shows two terminals. However, there are a plurality of terminals 140 that can access the server 120 in different embodiments. In some embodiments, there are one or more terminals 140 corresponding to a developer. A development and editing platform of a client that supports a social function is installed on the terminal 140. The developer can edit and update the client on the terminal 140, and transmit an updated application installation package to the server 120 over a wired or wireless network. The first terminal 110 and the second terminal 130 can download the application installation package from the server 120 to update the client.

The first terminal 110, the second terminal 130, and the another terminal 140 are connected to the server 120 over a wireless network or a wired network.

The server 120 includes at least one of a server, a plurality of servers, a cloud computing platform, and a virtualization center. The server 120 is configured to provide a background service for the client that supports the social function. In some embodiments, the server 120 undertakes primary computing work and the terminals undertake secondary computing work; or the server 120 undertakes secondary computing work and the terminals undertake primary computing work; or a distributed computing architecture is used between the server 120 and the terminals for collaborative computing.

For example, the server 120 includes a processor 122, a user account database 123, a social service module 124, and a user-oriented input/output interface (I/O interface) 125. The processor 122 is configured to load instructions stored in the server 120 and process data in the user account database 123 and the social service module 124. The user account database 123 is configured to store data of user accounts used by the first terminal 110, the second terminal 130, and the another terminal 140, for example, avatars of the user accounts, nicknames of the user accounts, and groups to which the user accounts belong. The social service module 124 is configured to provide a plurality of chat rooms (double chat or multi chat) for users to chat, send stickers, send red envelopes, and the like for instant messaging, publish and browse social circle messages, and feed back a user emotion. The user-oriented I/O interface 125 is configured to establish communication and exchange data with the first terminal 110 and/or the second terminal 130 over a wireless network or a wired network.

With reference to the foregoing implementation environment descriptions, the user emotion feedback method provided in some embodiments is described, and an example in which the method is performed by a client running on the terminal shown in FIG. 7 is used for description. The terminal runs the client, and the client is an application that supports the social function.

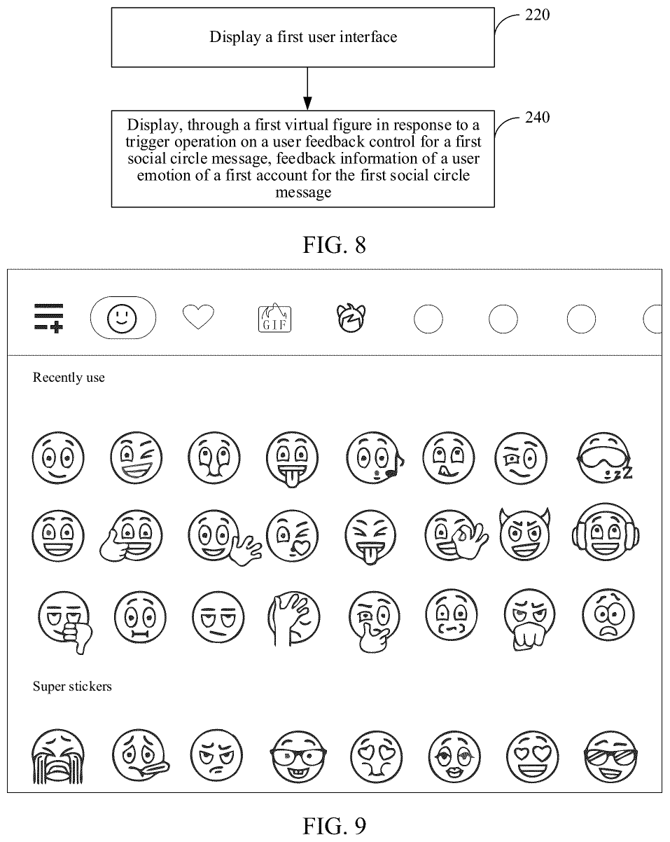

FIG. 8 is a flowchart of a user emotion feedback method according to some embodiments. In some embodiments, an example in which the method is performed by the first client shown in FIG. 7 is used for description, the first client being logged in with a first account. The method includes:

Operation 220: Display a first user interface.

The first user interface is an interface that is displayed on the first client and that is configured for displaying a social circle message. The first user interface includes a first social circle message posted by a second account. The second account is a publisher of the first social circle message. In some embodiments, the second account has a social friend relationship with the first account.

The first social circle message may be at least one of a text message, an image message, a video message, an audio message, and a symbol message. For example, the first social circle message may be a friend's post in a social circle, an article in a personal blog, a message of a photographed short video, or a message of a produced song.

In some embodiments, the first user interface further includes a user feedback control for the first social circle message. The user feedback control is a control configured for providing emotion feedback on the first social circle message, for example, a like control, a comment control, or a favorite control.

Operation 240: Display, through a first virtual figure in response to a trigger operation on the user feedback control for the first social circle message, feedback information of a user emotion of the first account for the first social circle message, the first virtual figure being a virtual figure corresponding to the first account.

The feedback information of the user emotion is at least one of image information, text information, video information, audio information, and symbol information.

In some embodiments, a user emotion expressed by the feedback information of the user emotion is at least one of happiness, sadness, anger, and fear. In some embodiments, the user emotion expressed by the feedback information of the user emotion is at least one of approval or disapproval. In some embodiments, the user emotion expressed by the feedback information of the user emotion is at least one of positive or negative. This is not limited in this application.

In some embodiments, the trigger operation includes at least one of a click/tap operation, a touch and hold operation, a double-click/tap operation, a drag operation, a voice operation, a pressure touch operation, eye control, and somatosensory control. This is not limited in this application.

In some embodiments, the feedback information of the user emotion of the first account for the first social circle message may be displayed in the center of a position of the first social circle message, or displayed in the center of the first user interface, or displayed near the user feedback control. This is not limited in this application.

In some embodiments, the feedback information of the user emotion of the first account for the first social circle message may be displayed in a form of an animation, or displayed in a form of a floating layer, or displayed in a three-dimensional manner through a three-dimensional figure of the first virtual figure. For example, the user feedback information obtained based on the first virtual figure is enlarged and displayed in the center of the position of the first social circle message, and the display is canceled after a period of time. For another example, an animation based on the first virtual figure is displayed on the first social circle message in the form of a floating layer, and is zoomed out into a thumbnail after a period of time and displayed near the user feedback control. This is not limited in this application.

The feedback information of the user emotion of the first account for the first social circle message includes the following three types:

(1) The feedback information of the user emotion is the first virtual figure having an emotion.

For example, at least one candidate figure is displayed based on the first virtual figure in response to a first trigger operation on the user feedback control for the first social circle message, different candidate figures being first virtual figures having different emotions. In response to a second trigger operation on a target figure of the at least one candidate figure, the target figure is displayed as the feedback information of the user emotion of the first account for the first social circle message. For example, as shown in FIG. 3, at least one candidate FIG. 44 is displayed based on a first virtual figure in response to the first trigger operation on the user feedback control 43 for the first social circle message 42, different candidate FIG. 44 being first virtual figures having different emotions. In response to a second trigger operation on a target figure of at least one candidate FIG. 44, the target figure 45 is displayed as the feedback information of the user emotion of the first account for the first social circle message.

In some embodiments, the candidate figure includes at least one of the following:
the first virtual figure having a happy emotion;
the first virtual figure having a sad emotion;
the first virtual figure having an angry emotion; and
the first virtual figure having a fearful emotion.

An emotion of the first virtual figure is not limited thereto. For example, the happy emotion may be replaced with an emotion such as smiling, laughing, or pleasant. For another example, the sad emotion may be replaced with an emotion such as crying, melancholy, or upset. This is not limited in some embodiments.

In some embodiments, the first virtual figure having an emotion may be a three-dimensional first virtual figure having an emotion, or may be a first virtual figure having an action corresponding to the emotion, or may be a combination of the first virtual figure having an emotion with a virtual figure for representing the emotion (such as an emotion sticker). The emotion sticker is a sticker configured for emotion representation included in a social application. FIG. 9 shows stickers configured for emotion representation included in a social application. The stickers may be used in a chat function, a social circle function, a video channel function, and the like of the social application.

(2) The feedback information of the user emotion is the first virtual figure having a first emotion, and the first emotion corresponds to an online state of the second account.

For example, in response to a third trigger operation on the user feedback control for the first social circle message, when the second account is online and the online state is set for the second account, the first virtual figure having the first emotion is displayed as the feedback information of the user emotion of the first account for the first social circle message, the first emotion corresponding to the online state.

In some embodiments, when the second account is online and the online state is set for the second account, in response to a third trigger operation on the user feedback control for the first social circle message, the first virtual figure and a second virtual figure that have the first emotion are displayed as the feedback information of the user emotion of the first account for the first social circle message, the second virtual figure being a virtual figure corresponding to the second account. In other words, the feedback information of the user emotion of the first account for the first social circle message includes both the first virtual figure and the second virtual figure.

In some embodiments, the online state set for the second account is at least one of a happy state, a sad state, a leisure state, and a hardworking state. In some embodiments, the online state set for the second account is at least one of an online state, an away state, a busy state, a do-not-disturb state, and an invisible state. In some embodiments, the online state set for the second account is at least one of a working state, a traveling state, a home state, an exercising state, a single state, and an in-a-relationship state.

In some embodiments, the feedback information of the user emotion includes at least one of the following:

When the second account is online and the online state set for the second account is the happy state, the first emotion is a happy emotion corresponding to the happy state, and the first virtual figure and the second virtual figure that have the happy emotion may be displayed as the feedback information of the user emotion of the first account for the first social circle message.

When the second account is online and the online state set for the second account is the sad state, the first emotion is an encouraging emotion corresponding to the sad state, and the first virtual figure and the second virtual figure that have the encouraging emotion may be displayed as the feedback information of the user emotion of the first account for the first social circle message. For example, as shown in FIG. 4(a), in response to a third trigger operation on the user feedback control 56 for the first social circle message 52, when the second account is online and the online state set for the second account is a sad state (for example, the online state is “lost”), a first virtual figure and a second virtual figure that have an encouraging emotion (for example, feedback information 53) are displayed as the feedback information of the user emotion of the first account for the first social circle message.

When the second account is online and the online state set for the second account is the leisure state, the first emotion is a relaxed emotion corresponding to the leisure state, and the first virtual figure and the second virtual figure that have the relaxed emotion may be displayed as the feedback information of the user emotion of the first account for the first social circle message. For example, as shown in FIG. 4(b), in response to a third trigger operation on the user feedback control 56 for the first social circle message 52, when the second account is online and the online state set for the second account is a leisure state (for example, the online state is “leisure”), a first virtual figure and a second virtual figure that have a relaxed emotion (for example, feedback information 54) are displayed as the feedback information of the user emotion of the first account for the first social circle message.

When the second account is online and the online state set for the second account is the hardworking state, the first emotion is a focused emotion corresponding to the hardworking state, and the first virtual figure and the second virtual figure that have the focused emotion may be displayed as the feedback information of the user emotion of the first account for the first social circle message. For example, as shown in FIG. 4(c), in response to a third trigger operation on the user feedback control 56 for the first social circle message 52, when the second account is online and the online state set for the second account is a hardworking state (for example, the online state is “hardworking”), a first virtual figure and a second virtual figure that have a focused emotion (for example, feedback information 55) are displayed as the feedback information of the user emotion of the first account for the first social circle message.

In some embodiments, the first virtual figure having the first emotion may be a three-dimensional first virtual figure having the first emotion, or may be the first virtual figure and the second virtual figure that have the first emotion, or may be a combination of the first virtual figure and the second virtual figure that have the first emotion with a template icon corresponding to the first emotion.

(3) The feedback information of the user emotion is the first virtual figure having a second emotion, and the second emotion corresponds to an intimate relationship (which may also be referred to as a social relationship) between the first account and the second account.

For example, in response to a fourth trigger operation on the user feedback control for the first social circle message, when an intimate relationship exists between the first account and the second account, the first virtual figure having the second emotion is displayed as the feedback information of the user emotion of the first account for the first social circle message, the second emotion corresponding to the intimate relationship.

In some embodiments, in response to a fourth trigger operation on the user feedback control for the first social circle message, when an intimate relationship exists between the first account and the second account, the first virtual figure and the second virtual figure that have the second emotion are displayed as the feedback information of the user emotion of the first account for the first social circle message, the second emotion corresponding to the intimate relationship, and the second virtual figure being a virtual figure corresponding to the second account. In other words, the feedback information of the user emotion of the first account for the first social circle message includes both the first virtual figure and the second virtual figure.

The intimate relationship includes at least one of a couple relationship, a brother relationship, a sister relationship, and a friend relationship.

In some embodiments, the feedback information of the user emotion includes at least one of the following:

When the intimate relationship between the first account and the second account is the couple relationship, the second emotion is a loving emotion corresponding to the couple relationship, and the first virtual figure and the second virtual figure that have the loving emotion may be displayed as the feedback information of the user emotion of the first account for the first social circle message. For example, as shown in FIG. 6(a), in response to a fourth trigger operation on the user feedback control 63 for the first social circle message 62, when the intimate relationship between the first account and the second account is a couple relationship, a first virtual figure and a second virtual figure that have a loving emotion (for example, feedback information 64) are displayed as the feedback information of the user emotion of the first account for the first social circle message.

When the intimate relationship between the first account and the second account is the brother relationship, the second emotion is an excited emotion corresponding to the brother relationship, and the first virtual figure and the second virtual figure that have the excited emotion may be displayed as the feedback information of the user emotion of the first account for the first social circle message.

When the intimate relationship between the first account and the second account is a sister relationship, the second emotion is a shy emotion corresponding to the sister relationship, and the first virtual figure and the second virtual figure that have the shy emotion may be displayed as the feedback information of the user emotion of the first account for the first social circle message. For example, as shown in FIG. 6(b), in response to a fourth trigger operation on the user feedback control 63 for the first social circle message 62, when the intimate relationship between the first account and the second account is a sister relationship, a first virtual figure and a second virtual figure that have a shy emotion (for example, feedback information 65) are displayed as the feedback information of the user emotion of the first account for the first social circle message.

When the intimate relationship between the first account and the second account is a friend relationship, the second emotion is a pleasant emotion corresponding to the friend relationship, and the first virtual figure and the second virtual figure that have the pleasant emotion may be displayed as the feedback information of the user emotion of the first account for the first social circle message.

In some embodiments, the first virtual figure having the second emotion may be a three-dimensional first virtual figure having the second emotion, or may be the first virtual figure and the second virtual figure that have the second emotion, or may be a combination of the first virtual figure and the second virtual figure that have the second emotion with a template icon corresponding to the second emotion.

In some implementations, the first trigger operation is a touch and hold operation, and the second trigger operation, the third trigger operation, and the fourth trigger operation are click/tap operations. In other words, the candidate figure is displayed when a touch and hold operation is performed on the user feedback control for the first social circle message. When a click/tap operation is performed on the user feedback control for the first social circle message, to-be-displayed feedback information is determined based on the online state of the second account or the intimate relationship between the first account and the second account.

In conclusion, according to the method provided in some embodiments, the user feedback control for the first social circle message is triggered, and the feedback information of the user emotion for the first social circle message is displayed through the first virtual figure corresponding to the first account, so that user emotion feedback on a social circle message can be associated with a user account providing the feedback. This diversifies manners of feeding back a user emotion, enhances an effect of the user emotion feedback, and improves human-computer interaction efficiency.

In addition, in a manner of displaying the feedback information of the corresponding user emotion based on the online state of the second account, the user feedback is combined with the online state set for the second account, and functions in the social application are combined, so that the user emotion feedback is closely aligned with a life of the user, thereby improving experience of the user.

In addition, in a manner of displaying the feedback information of the corresponding user emotion based on the intimate relationship between the first account and the second account, the user feedback is combined with the intimate relationship between the users. The corresponding feedback information is displayed, so that a connection between the users is strengthened, and user experience is further improved.

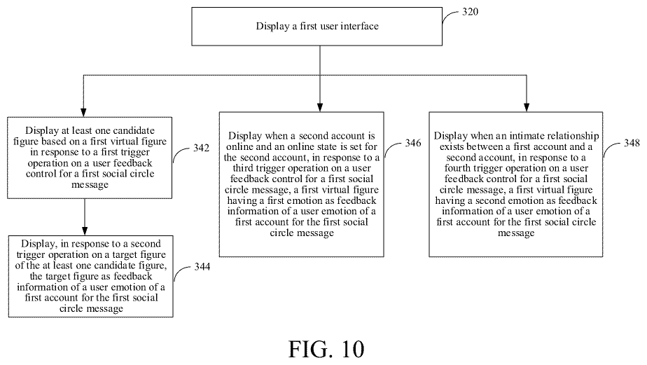

FIG. 10 is a flowchart of a user emotion feedback method according to some embodiments. In some embodiments, an example in which the method is performed by the first client shown in FIG. 7 is used for description, the first client being logged in with a first account. The method includes:

Operation 320: Display a first user interface.

The first user interface includes a first social circle message posted by a second account.

The first user interface is an interface that is displayed on the first client and that is configured for displaying a social circle message. The first user interface includes the first social circle message posted by the second account. The second account is a publisher of the first social circle message. In some embodiments, the second account has a social friend relationship with the first account.

In some embodiments, the first user interface further includes a user feedback control (such as a like control, a comment control, or a favorite control) for the first social circle message.

For example, the first social circle message may be at least one of a text message, an image message, a video message, an audio message, and a symbol message. For example, the first social circle message may be a friend's post in a social circle, an article in a personal blog, a message of a photographed short video, or a message of a produced song.

One of the following operation 342 and operation 344, operation 346, and operation 348 is selected to be performed. When feedback information of a user emotion is a first virtual figure having an emotion, operation 342 and operation 344 are performed. When feedback information of a user emotion is a first virtual figure having a first emotion, and the first emotion corresponds to an online state of the second account, operation 346 is performed. When feedback information of a user emotion is a first virtual figure having a second emotion, and the second emotion corresponds to an intimate relationship between the first account and the second account, operation 348 is performed.

Operation 342: Display at least one candidate figure based on the first virtual figure in response to a first trigger operation on the user feedback control for the first social circle message, different candidate figures being first virtual figures having different emotions.

The candidate figure includes at least one of the following:
the first virtual figure having a happy emotion;
the first virtual figure having a sad emotion;
the first virtual figure having an angry emotion; and
the first virtual figure having a fearful emotion.

The candidate figures are the first virtual figures having different emotions, and the different emotions are determined by a server. In other words, the first client transmits, to the server, signaling for obtaining an emotion sticker corresponding to the candidate figure. The first client obtains the emotion sticker corresponding to the candidate figure transmitted by the server, for example, an identity (identity, ID) of the emotion sticker corresponding to the candidate figure is transmitted.

In some embodiments, a mark indicating whether the emotion sticker has been requested is set in the first client. When the emotion sticker is not marked as requested, the signaling for obtaining the emotion sticker corresponding to the candidate figure is transmitted to the server. In addition, after the emotion sticker transmitted by the server is obtained, the emotion sticker is marked as requested.

FIG. 11 is a flowchart of the first client obtaining the emotion sticker from the server. The following operations are included.

Operation 3421: A user enters a space state panel. For example, the first account clicks/taps a social circle to browse the first social circle message posted by the second account.

Operation 3422: The first client detects whether the emotion sticker has been requested. If the emotion sticker has been requested, the first client does not perform subsequent operations of obtaining the emotion sticker. If the emotion sticker has not been requested, the first client performs operation 3423 to request for the emotion sticker. To prevent the first client from repeatedly requesting the server for duplicate emotion sticker data, the first client sets the mark indicating whether the emotion sticker has been requested, and requests for the emotion sticker only when the mark indicating that the emotion sticker has not been requested.

Operation 3423: The first client requests for the emotion sticker. When it is determined in operation 3422 that the first client has not requested for the emotion sticker, this operation is performed. In other words, the first client transmits, to the server, the signaling for obtaining the emotion sticker corresponding to the candidate figure.

Operation 3424: The server performs a security check. After receiving the signaling for obtaining the emotion sticker corresponding to the candidate figure that is transmitted by the first client, the server performs identity check on the first account logged into on the first client.

Operation 3425: The server determines whether the request for obtaining the emotion sticker by the first client is valid. Operation 3427 and other operations of determining the emotion sticker are performed when the request is valid. Operation 3426 is performed, the server does not return the emotion sticker, when the request is invalid.

Operation 3426: The first client updates an emotion sticker list to be empty. When the server determines that the request for obtaining the emotion sticker by the first client is invalid, this operation is performed, the first client updates the emotion sticker list to be empty. When the emotion sticker list is empty, the candidate figure is not displayed when the first trigger operation is performed on the user feedback control.

Operation 3427: The server determines an emotion sticker according to emotion sticker operation policy logic. When the server determines that the request for obtaining the emotion sticker by the first client is valid, this operation is performed, based on a requirement on a service side of a social application, the emotion sticker is determined according to a policy logic of running an emotion sticker of the social application, in other words, an emotion sticker that may be sent to a terminal for generating the candidate figure is determined.

Operation 3428: The server sends the emotion sticker to the first client. The server sends the emotion sticker determined in operation 3427 to the first client. In other words, the server sends an identity of the emotion sticker to the first client.

Operation 3429: The first client updates the emotion sticker list. The first client updates the emotion sticker list after receiving the emotion sticker sent by the server. An emotion sticker in the emotion sticker list is configured for generating a candidate figure. The first client receives the identity of the emotion sticker sent by the server, obtains the emotion sticker in the social application based on the identity, and updates the emotion sticker list.

In some embodiments, in the emotion sticker list, identities of emotion stickers are in one-to-one correspondence with the first virtual figures having different emotions.

Operation 3430: The first client marks the emotion sticker as requested. To prevent the first client from repeatedly requesting the server for duplicate emotion sticker data, when the first client already obtains the emotion sticker sent by the server, the emotion sticker is marked as requested.

Operation 344: Display, in response to a second trigger operation on a target figure of the at least one candidate figure, the target figure as feedback information of a user emotion of the first account for the first social circle message.

For example, the first account selects the target figure of the at least one candidate figure, and the first client displays the target figure as the feedback information of the user emotion of the first account for the first social circle message.

For example, in response to the second trigger operation on the target figure of the at least one candidate figure, the first client transmits first feedback request signaling to the server, the first feedback request signaling including the first account and an identity of an emotion sticker corresponding to the target figure; and receives first feedback response signaling transmitted by the server, the first feedback response signaling being configured for indicating whether user emotion feedback succeeds, and successful user emotion feedback indicating using the target figure as the feedback information of the user emotion of the first account for the first social circle message.

In other words, after the user determines the target figure from the candidate figures, the terminal transmits a request for displaying the target figure, for example, the first feedback request signaling, to the server. The server returns first feedback response signaling, to indicate whether the user emotion feedback succeeds. After receiving the first feedback response signaling transmitted by the server, when the first feedback response signaling indicates that the user emotion feedback succeeds, the terminal uses the target figure as the feedback information of the user emotion of the first account for the first social circle message, and displays the target figure on the first client.

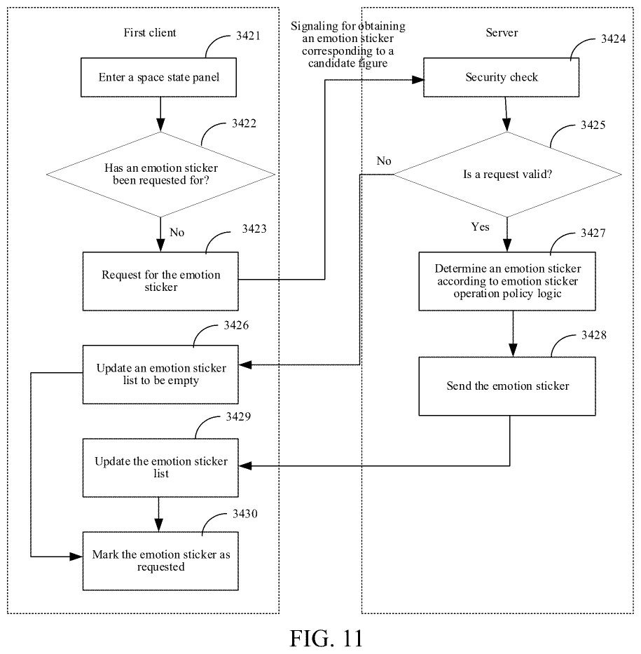

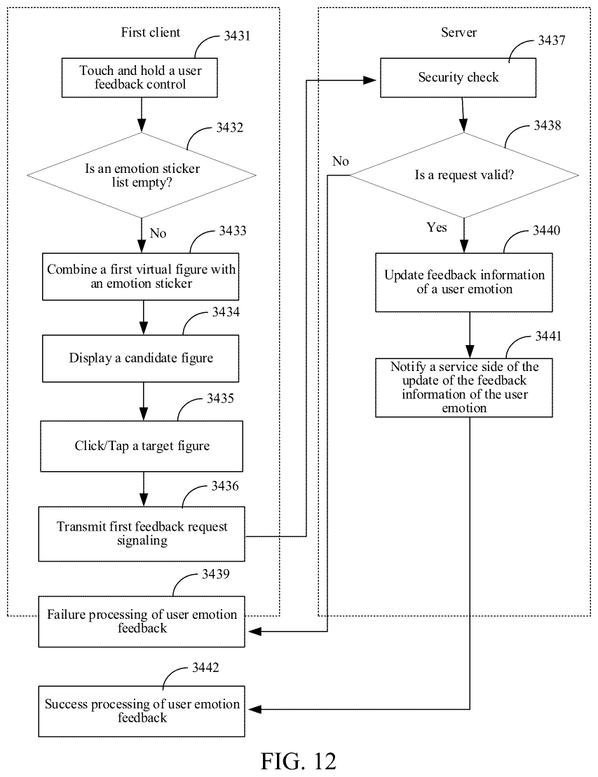

FIG. 12 is a flowchart of a user emotion feedback method. The method shows an interaction process between the first client and the server in operation 342 and operation 344. The method includes the following operations:

Operation 3431: The user touches and holds the user feedback control. Using an example in which the first trigger operation is a touch and hold operation, the user obtains the candidate figures by touching and holding the user feedback control and performs selection from the candidate figures.

Operation 3432: The first client determines whether the emotion sticker list is empty. In operation 3426, the first client determines that the emotion sticker list is empty, and subsequent operations are not performed. When the first client determines that the emotion sticker list is not empty, for example, when operation 3429 is performed, subsequent operation 3433 is performed.

Operation 3433: The first client combines the first virtual figure with the emotion sticker. When it is determined in operation 3432 that the emotion sticker list is not empty, this operation is performed. The emotion sticker list includes identities of emotion stickers in one-to-one correspondence and the first virtual figure having the emotion sticker. The emotion sticker is combined with the first virtual figure having the emotion sticker to generate the candidate figure. For example, the candidate figure is the first virtual figure having the emotion sticker, and the emotion sticker is displayed at a lower right corner of the first virtual figure.

Operation 3434: The first client displays the candidate figure. After the candidate figure is obtained, the candidate figure is displayed on the first user interface of the first account.

Operation 3435: The user clicks/taps the target figure. Using an example in which the second trigger operation is a click/tap operation, the user selects the target figure from the at least one candidate figure and selects the target figure through the click/tap operation.

Operation 3436: The first client transmits the first feedback request signaling to the server. The first feedback request signaling is configured for requesting to display the target figure on the first user interface as the feedback information of the user emotion of the first account for the first social circle message, and the first feedback request signaling includes the first account and the identity of the emotion sticker corresponding to the target figure. The first account is used by the server for performing security check and obtaining the first virtual figure corresponding to the first account, and the identity of the emotion sticker corresponding to the target figure is configured for obtaining the emotion sticker.

Operation 3437: The server performs the security check. The server performs the security check on a first feedback request, for example, checks whether the first account has a permission to feed back a user emotion.

Operation 3438: The server determines whether the request is valid. When the server determines that the first feedback request is valid, subsequent operation 3440 and the like is performed. When the server determines that the first feedback request is invalid, operation 3439 is performed, the first feedback response signaling indicating that user emotion feedback fails is transmitted to the terminal.

Operation 3439: The first client performs failure processing of the user emotion feedback. When the server determines that the first feedback request is invalid, this operation is performed. The first account cannot provide the user emotion feedback on the first social circle message, and feedback information of the user emotion is not displayed on the first user interface.

Operation 3440: The server updates the feedback information of the user emotion. In other words, the server stores the feedback information of the user emotion.

Operation 3441: The server notifies the service side of the update of the feedback information of the user emotion. The server transmits, to the first client, the first feedback response signaling indicating that the user emotion feedback succeeds. The successful user emotion feedback indicates that the target figure is displayed on the first user interface as the feedback information of the user emotion of the first account for the first social circle message.

Operation 3442: The first client performs success processing of the user emotion feedback. After the first client receives the first feedback response signaling transmitted by the server, the first client displays the target figure on the first user interface as the feedback information of the user emotion of the first account for the first social circle message.

Operation 346: Display when the second account is online and the online state is set for the second account, in response to a third trigger operation on the user feedback control for the first social circle message, the first virtual figure having the first emotion as the feedback information of the user emotion of the first account for the first social circle message,

the first emotion corresponding to the online state. The online state includes at least one of a happy state, a sad state, a leisure state, and a hardworking state.

In some embodiments, the first emotion corresponding to the happy state is a happy emotion. The first emotion corresponding to the sad state is an encouraging emotion. The first emotion corresponding to the leisure state is a relaxed emotion. The first emotion corresponding to the hardworking state is a focused emotion.

In some embodiments, the first emotion is an interaction emotion between the first virtual figure and a second virtual figure. For example, when the online state of the second account is the sad state, the first emotion is configured for expressing comfort or encouragement of the first virtual figure for the second virtual figure. For another example, when the online state of the second account is the leisure state, the first emotion is configured for expressing that the first virtual figure and the second virtual figure are both leisure or relaxed.

In some embodiments, when the second account is online and the online state is set for the second account, in response to a third trigger operation on the user feedback control for the first social circle message, the first virtual figure and the second virtual figure that have the first emotion are displayed as the feedback information of the user emotion of the first account for the first social circle message, the second virtual figure being a virtual figure corresponding to the second account. In other words, the feedback information of the user emotion of the first account for the first social circle message includes both the first virtual figure and the second virtual figure.

For example, second feedback request signaling is transmitted to the server, the second feedback request signaling being configured for obtaining the first virtual figure having the first emotion, and the second feedback request signaling including the first account. The second feedback response signaling transmitted by the server is received, the second feedback response signaling including a picture link (which may also referred to as a resource link) of the first virtual figure having the first emotion. The first virtual figure having the first emotion is downloaded based on the picture link.

FIG. 13 is a flowchart of a user emotion feedback method. The method shows an interaction process between the first client and the server in operation 346. The method includes the following operations:

Operation 3461: The user clicks/taps the user feedback control. Using an example in which the third trigger operation is a click/tap operation, the user clicks/taps the user feedback control to feed back a user emotion. The first client transmits the second feedback request signaling to the server, the second feedback request signaling being configured for obtaining the first virtual figure having the first emotion, and the second feedback request signaling including the first account.

Operation 3462: The server determines whether the second account is online. When the second account is online, operation 3464 and subsequent operations are performed. When the second account is offline, operation 3463 is performed.

Operation 3463: The server sets a resource link of the feedback information of the user emotion to null. When the second account is offline or the online state is not set for the second account, the server sets the resource link of the feedback information of the user emotion to null.

Operation 3464: The server determines whether the online state exists. The server determines whether the online state is set for the second account. When the online state is set for the second account, subsequent operation 3465 and the like are performed. When the online state is not set for the second account, operation 3463 is performed.

Operation 3465: The server obtains virtual figures of the first account and the second account. The server obtains, based on the first account in the second feedback request signaling, the first virtual figure corresponding to the first account, and obtains the second virtual figure corresponding to the second account that posts the first social circle message.

Operation 3466: The server generates the feedback information of the user emotion. The server generates the feedback information of the user emotion based on the first virtual figure and the second virtual figure. For example, each online state corresponds to a feedback template, and the first virtual figure and the second virtual figure are combined with the feedback template corresponding to the online state, to obtain the feedback information of the user emotion.

In some embodiments, when generating the feedback information of the user emotion, the server assigns, to the generated feedback information of the user emotion, a tag that can be uniquely identified, so that generation does not may be repeated for a plurality of times subsequently. The uniquely identified tag includes an ID of the virtual figure of the first account, an ID of the virtual figure of the second account, and an ID of the online state. IDs of online states are in one-to-one correspondence with feedback templates corresponding to the online states. In this operation, if it is determined, based on the uniquely identified tag, that the feedback information of the user emotion is generated, subsequent operation 3467 does not may be performed, and instead, operation 3468 is directly performed.

Operation 3467: The server generates a picture link of the feedback information of the user emotion. The server generates the picture link of the feedback information of the user emotion based on the feedback information of the user emotion.

Operation 3468: The server sends the picture link of the feedback information of the user emotion to the first client, the server transmits the second feedback response signaling to the first client, the second feedback response signaling including the picture link of the feedback information of the user emotion.

Operation 3469: The first client performs success processing of the user emotion feedback. After receiving the second feedback response signaling transmitted by the server, the first client confirms that the user emotion feedback succeeds, and then performs subsequent operations of obtaining the feedback information of the user emotion.

Operation 3470: The first client determines whether the picture link of the feedback information of the user emotion is null. When it is determined that the picture link of the feedback information of the user emotion is null, operation 3471 is performed. When it is determined that the picture link of the feedback information of the user emotion is not null, operation 3472 is performed.

Operation 3471: The first client displays feedback information of another user emotion. When the first client determines that the picture link of the feedback information of the user emotion is null or the first client determines that the feedback information of the user emotion is unsuccessful downloaded, the first client displays feedback information of a user emotion that is determined in another manner.

Operation 3472: The first client downloads the feedback information of the user emotion. The first client downloads the feedback information of the user emotion based on the picture link of the feedback information of the user emotion.

Operation 3473: The first client determines whether the feedback information of the user emotion is successfully downloaded. When the first client determines that the downloading succeeds, operation 3474 is performed. When the first client determines that the downloading is unsuccessful, operation 3471 is performed.

Operation 3474: The first client displays the feedback information of the user emotion. When the first client determines that the downloading succeeds in operation 3473, this operation is performed, the feedback information of the user emotion is displayed on the first user interface.

Operation 348: Display when an intimate relationship exists between the first account and the second account, in response to a fourth trigger operation on the user feedback control for the first social circle message, the first virtual figure having the second emotion as the feedback information of the user emotion of the first account for the first social circle message,

the second emotion corresponding to the intimate relationship. In some embodiments, the intimate relationship includes at least one of a couple relationship, a brother relationship, a sister relationship, and a friend relationship. The second emotion corresponding to the couple relationship is a loving emotion. The second emotion corresponding to the brother relationship is an excited emotion. The second emotion corresponding to the sister relationship is a shy emotion. The second emotion corresponding to the friend relationship is a pleasant emotion.

In some embodiments, the second emotion is an interaction emotion between the first virtual figure and the second virtual figure. For example, when the intimate relationship is the couple relationship, the second emotion is configured for expressing love of the first virtual figure for the second virtual figure. For another example, when the intimate relationship is the friend relationship, the second emotion is configured for expressing accompany of the first virtual figure for the second virtual figure.

For example, in response to the fourth trigger operation on the user feedback control for the first social circle message, when the intimate relationship exists between the first account and the second account, the first virtual figure and the second virtual figure that have the second emotion are displayed as the feedback information of the user emotion of the first account for the first social circle message, the second virtual figure being the virtual figure corresponding to the second account.

For example, third feedback request signaling is transmitted to the server, the third feedback request signaling being configured for obtaining the first virtual figure having the second emotion, and the third feedback request signaling including the first account. The third feedback response signaling transmitted by the server is received, the third feedback response signaling including a picture link of the first virtual figure having the second emotion. The first virtual figure having the second emotion is downloaded based on the picture link.

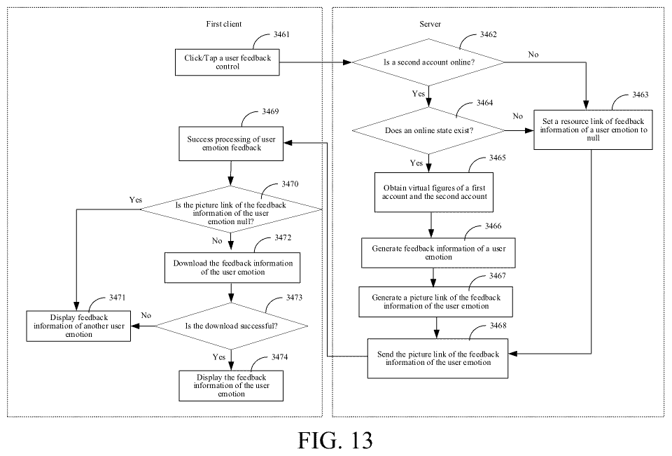

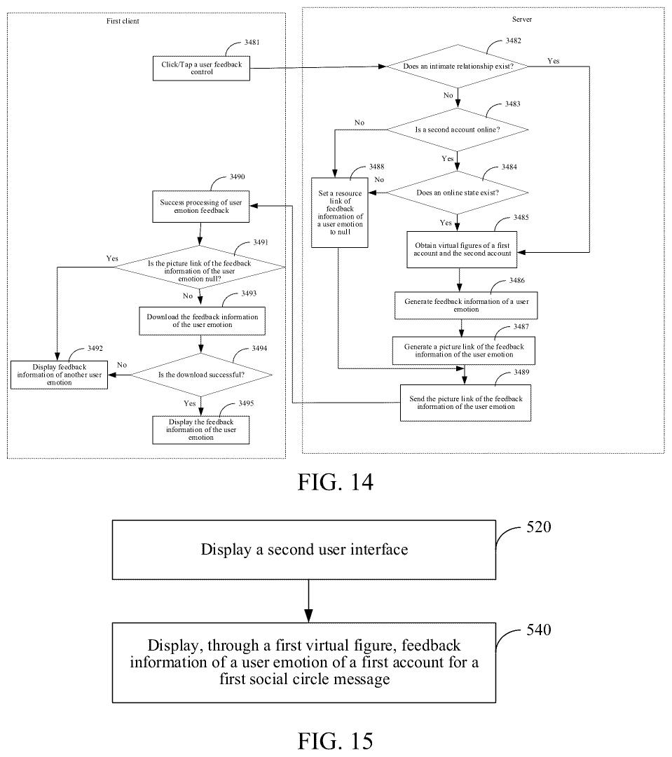

FIG. 14 is a flowchart of a user emotion feedback method. The method shows an interaction process between the first client and the server in operation 348. The method includes the following operations:

Operation 3481: The user clicks/taps the user feedback control. Using an example in which the fourth trigger operation is a click/tap operation, the user clicks/taps the user feedback control to feed back a user emotion. The first client transmits the third feedback request signaling to the server, the third feedback request signaling being configured for obtaining the first virtual figure having the second emotion, and the third feedback request signaling including the first account.

Operation 3482: The server determines whether the intimate relationship exists. The server determines whether the intimate relationship exists between the first account and the second account. When the intimate relationship exists, operation 3483 and operation 3484 are omitted, and operation 3485 is performed. When the intimate relationship does not exist, operation 3483 is performed.

Operation 3483: The server determines whether the second account is online. When the server determines, in operation 3482, that the intimate relationship does not exist between the first account and the second account, this operation is performed. When the second account is online, operation 3484 and subsequent operations are performed. When the second account is offline, operation 3488 is performed.

Operation 3484: The server determines whether the online state exists. The server determines whether the online state is set for the second account. When it is determined in operation 3483 that the second account is online, this operation is performed. When the online state is set for the second account, subsequent operation 3485 and the like are performed. When the online state is not set for the second account, operation 3488 is performed.

Operation 3485: The server obtains virtual figures of the first account and the second account. The server obtains the first virtual figure corresponding to the first account based on the first account in the third feedback request signaling, and obtains the second virtual figure corresponding to the second account that posts the first social circle message.

Operation 3486: The server generates the feedback information of the user emotion. The server generates the feedback information of the user emotion based on the first virtual figure and the second virtual figure.

In some embodiments, when the feedback information of the user emotion is generated, a priority of the intimate relationship is higher than a priority of the online state. For example, when the intimate relationship exists between the first account and the second account, each intimate relationship corresponds to a feedback template, and the first virtual figure and the second virtual figure are combined with the feedback template corresponding to the intimate relationship, to obtain the feedback information of the user emotion. When the intimate relationship does not exist between the first account and the second account, whether the second account is online and whether the online state is set is then determined. When the second account is online and the online state is set, each online state corresponds to a feedback template. The first virtual figure and the second virtual figure are combined with a feedback template corresponding to the online state, to obtain the feedback information of the user emotion.

Operation 3487: The server generates a picture link of the feedback information of the user emotion. The server generates the picture link of the feedback information of the user emotion based on the feedback information of the user emotion. After operation 3487 is performed, operation 3489 is performed.

Operation 3488: The server sets a resource link of the feedback information of the user emotion to null. When the second account is offline or the online state is not set for the second account, the server sets the resource link of the feedback information of the user emotion to null.

Operation 3489: The server sends the picture link of the feedback information of the user emotion to the first client.

Operation 3490: The first client performs success processing of the user emotion feedback. After receiving the third feedback response signaling transmitted by the server, the third feedback response signaling including the picture link of the feedback information of the user emotion, the first client confirms that the user emotion feedback succeeds, and then performs subsequent operations of obtaining the feedback information of the user emotion.

Operation 3491: The first client determines whether the picture link of the feedback information of the user emotion is null. When it is determined that the picture link of the feedback information of the user emotion is null, operation 3492 is performed. When it is determined that the picture link of the feedback information of the user emotion is not null, operation 3493 is performed.

Operation 3492: The first client displays feedback information of another user emotion. When the first client determines that the picture link of the feedback information of the user emotion is null or the first client determines that the feedback information of the user emotion is unsuccessful downloaded, the first client displays feedback information of a user emotion that is determined in another manner.

Operation 3493: The first client downloads the feedback information of the user emotion. The first client downloads the feedback information of the user emotion based on the picture link of the feedback information of the user emotion.

Operation 3494: The first client determines whether the feedback information of the user emotion is successfully downloaded. When the first client determines that the downloading succeeds, operation 3495 is performed. When the first client determines that the downloading is unsuccessful, operation 3492 is performed.

Operation 3495: The first client displays the feedback information of the user emotion. When the first client determines that the downloading succeeds in operation 3494, this operation is performed, the feedback information of the user emotion is displayed on the first user interface.

In conclusion, according to the method provided in some embodiments, the user feedback control for the first social circle message is triggered, and the feedback information of the user emotion for the first social circle message is displayed through the first virtual figure corresponding to the first account, so that user emotion feedback on a social circle message can be associated with a user account providing the feedback. This diversifies manners of feeding back a user emotion, enhances an effect of the user emotion feedback, and improves human-computer interaction efficiency.

In addition, according to the method provided in some embodiments, three user emotion feedback manners that can convey an emotion through the first virtual figure are implemented. The user may flexibly select a manner based on a requirement or preference, and the user emotion feedback manner may be related to the online state and the intimate relationship, to better connect functions in a social client, so as to closely align with a real life of the user, thereby improving human-computer interaction efficiency.

In addition, according to the method provided in some embodiments, the feedback information of the user emotion is generated on the server side, so that a template of the feedback information of the user emotion can be updated without updating the client, to diversify user emotion feedback manners.

FIG. 15 is a flowchart of a user emotion feedback method according to some embodiments. In some embodiments, an example in which the method is performed by the second client shown in FIG. 7 is used for description, the second client being logged in with a second account. The method includes:

Operation 520: Display a second user interface.

The second user interface is an interface that is displayed on the second client and that is configured for displaying a social circle message. The second user interface includes a first social circle message posted by the second account. The second account is a publisher of the first social circle message. In some embodiments, the second account has a social friend relationship with a first account.

The first social circle message may be at least one of a text message, an image message, a video message, an audio message, and a symbol message. For example, the first social circle message may be a friend's post in a social circle, an article in a personal blog, a message of a photographed short video, or a message of a produced song.

In some embodiments, the second user interface further includes a user feedback control for the first social circle message. The user feedback control is a control configured for providing emotion feedback on the first social circle message, for example, a like control, a comment control, or a favorite control.

Operation 540: Display, through a first virtual figure, feedback information of a user emotion of the first account for the first social circle message, the first virtual figure being a virtual figure corresponding to the first account.

The feedback information of the user emotion is at least one of image information, text information, video information, audio information, and symbol information.

In some embodiments, a user emotion expressed by the feedback information of the user emotion is at least one of happiness, sadness, anger, and fear. In some embodiments, the user emotion expressed by the feedback information of the user emotion is at least one of approval or disapproval. In some embodiments, the user emotion expressed by the feedback information of the user emotion is at least one of positive or negative. This is not limited in this application.

For example, a target figure is displayed in a scrolling manner as the feedback information of the user emotion of the first account for the first social circle message, the target figure being the first virtual object having a target emotion. In other words, the target figure is feedback information selected by the first account from a plurality of candidate figures, and the target emotion is an emotion sticker corresponding to the target figure. For example, as shown in FIG. 3, a first virtual object 46 having an emotion is displayed on a second user interface 47 in a scrolling manner, and is used as the feedback information of the user emotion of the first account for the first social circle message. Scrolling display means that the feedback information of the user emotion of the first account for the first social circle message is displayed on the second user interface in a scrolling manner like bullet comments, for example, scrolling from right to left or scrolling from bottom to top. In some embodiments, the feedback information of the user emotion of the first account for the first social circle message is displayed on the second user interface in a scrolling manner like floating bubbles. For example, the feedback information of the user emotion floats from bottom to top in a form of bubbles, and a size of the bubble gradually decreases as the bubble floats up.

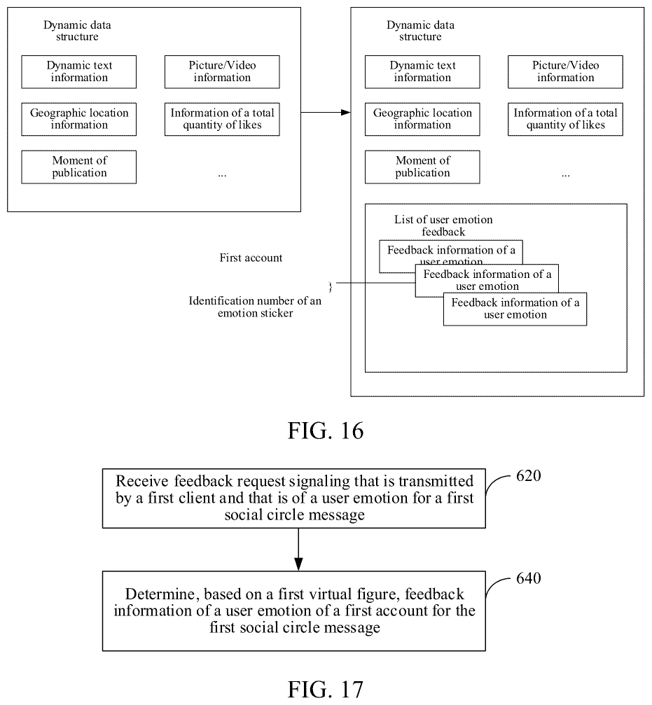

For example, the second client obtains a list of feedback information of the user emotion for the first social circle message from a server. The list includes the first account and an identity of an emotion sticker corresponding to the feedback information of the user emotion of the first account for the first social circle message. FIG. 16 shows dynamic data structures of the feedback information that is of the user emotion for the first social circle message and that is obtained by the second client. As shown in a left figure in FIG. 16, the dynamic data structure in some methods includes dynamic text information, picture/video information, geographic location information, and the like. As shown in a right figure of FIG. 16, the dynamic data structure of the feedback information of the user emotion for the first social circle message in the user emotion feedback method according to some embodiments further includes a user emotion feedback list. The list includes all feedback information of the user emotion for the first social circle message. Each piece of the feedback information of the user emotion includes a first account in one-to-one correspondence and an identity of an emotion sticker corresponding to the feedback information of the user emotion from the first account.

In some embodiments, when the second account is online and an online state is set for the second account, the first virtual figure having a first emotion is displayed as the feedback information of the user emotion of the first account for the first social circle message, the first emotion corresponding to the online state.

For example, when the second account is online and the online state is set for the second account, the first virtual figure having the first emotion is enlarged and displayed in the center as the feedback information of the user emotion of the first account for the first social circle message, the first emotion corresponding to the online state.

For example, when the second account is online and the online state is set for the second account, the first virtual figure and a second virtual figure that have the first emotion are displayed as the feedback information of the user emotion of the first account for the first social circle message, the first emotion corresponding to the online state. As shown in FIG. 4, when the second account is online and the online state is set for the second account, the first virtual figure and the second virtual figure that have the first emotion are enlarged and displayed at a position of the first social circle message, and when the online state of the second account varies, feedback information of different user emotions is enlarged and displayed.

In some embodiments, when an intimate relationship exists between the first account and the second account, the first virtual figure having a second emotion is displayed as the feedback information of the user emotion of the first account for the first social circle message.

For example, when the intimate relationship exists between the first account and the second account, the first virtual figure having the second emotion is enlarged and displayed in the center as the feedback information of the user emotion of the first account for the first social circle message.

For example, when the intimate relationship exists between the first account and the second account, the first virtual figure and the second virtual figure that have the second emotion are enlarged and displayed as the feedback information of the user emotion of the first account for the first social circle message. As shown in FIG. 6, when the intimate relationship exists between the first account and the second account, the first virtual figure and the second virtual figure that have the second emotion are enlarged and displayed at the position of the first social circle message, and when intimate relationships are different, feedback information of different user emotions is enlarged and displayed.

In conclusion, according to the method provided in some embodiments, the feedback information of the user emotion for the first social circle message is displayed through the first virtual figure corresponding to the first account, so that user emotion feedback on a social circle message can be associated with a user account providing the feedback. This diversifies manners of feeding back a user emotion, enhances an effect of the user emotion feedback, and improves human-computer interaction efficiency.

FIG. 17 is a flowchart of a user emotion feedback method according to some embodiments. In some embodiments, an example in which the method is performed by the server shown in FIG. 7 is used for description. The method includes:

Operation 620: Receive feedback request signaling that is transmitted by a first client and that is of a user emotion for a first social circle message,

the first social circle message being a social circle message posted by a second account. The first social circle message may be at least one of a text message, an image message, a video message, an audio message, and a symbol message. For example, the first social circle message may be a friend's post in a social circle, an article in a personal blog, a message of a photographed short video, or a message of a produced song.

A first account is a user account that logs into on the first client, and the second account is a user account that logs into on a second client.

The feedback request signaling includes the first account.

In some embodiments, the first feedback request signaling includes the first account and an identity of an emotion sticker corresponding to a target figure, and the first feedback request signaling is configured for requesting to display the target figure on a first user interface as feedback information of a user emotion of the first account for the first social circle message. Second feedback request signaling includes the first account, and the second feedback request signaling is configured for obtaining a first virtual figure having a first emotion. Third feedback request signaling includes the first account, and the third feedback request signaling is configured for obtaining the first virtual figure having a second emotion.

For example, the server receives the first feedback request signaling that is sent by the first client and that is of the user emotion for the first social circle message, for example, the first feedback request signaling transmitted by the first client in operation 3436 in some embodiments shown in FIG. 12.

For example, the server receives the second feedback request signaling that is sent by the first client and that is of the user emotion for the first social circle message, for example, the second feedback request signaling transmitted by the first client in operation 3461 in some embodiments shown in FIG. 13.

For example, the server receives the third feedback request signaling that is sent by the first client and that is of the user emotion for the first social circle message, for example, the third feedback request signaling transmitted by the first client in operation 3481 in some embodiments shown in FIG. 14.

Operation 640: Determine, based on the first virtual figure, the feedback information of the user emotion of the first account for the first social circle message,

the first virtual figure being a virtual figure corresponding to the first account.

The feedback information of the user emotion is at least one of image information, text information, video information, audio information, and symbol information.

(1) The feedback information of the user emotion is the first virtual figure having an emotion.

For example, a combination of the first virtual figure with an emotion sticker is determined as the feedback information of the user emotion of the first account for the first social circle message. For example, the three-dimensional first virtual figure is combined with the emotion sticker as the feedback information of the user emotion of the first account for the first social circle message.

In some embodiments, the server generates and stores the feedback information of the user emotion of the first account for the first social circle message.

In some embodiments, first feedback response signaling is transmitted to the first client, the first feedback response signaling being configured for indicating whether user emotion feedback succeeds. When the user emotion feedback succeeds, the feedback information is displayed on the first user interface. For example, refer to operation 3441 in some embodiments shown in FIG. 12. Details are not described herein again.

In some embodiments, signaling that is configured for obtaining an emotion sticker and that is transmitted by the first client is received. The emotion sticker is sent to the first account when it is checked that an identity of the first account is valid. For example, refer to operation 3424 to operation 3428 in some embodiments shown in FIG. 11. Details are not described herein again.

(2) The feedback information of the user emotion is the first virtual figure having the first emotion, and the first emotion corresponds to an online state of the second account.

The first virtual figure and a feedback template corresponding to the online state are obtained when the second account is online and the online state is set for the second account. The first virtual figure is combined with the feedback template corresponding to the online state, to determine the feedback information of the user emotion of the first account for the first social circle message. For example, the feedback template corresponding to the online state is preset, and the first virtual figure is combined with the feedback template to obtain the feedback information of the user emotion. For example, refer to operation 3465 and operation 3466 in some embodiments shown in FIG. 13. Details are not described herein again.

In some embodiments, a picture link of the feedback information is sent to the first client. For example, refer to operation 3468 in some embodiments shown in FIG. 13. Details are not described herein again.

(3) The feedback information of the user emotion is the first virtual figure having the second emotion, and the second emotion corresponds to an intimate relationship between the first account and the second account.

The first virtual figure and a feedback template corresponding to the intimate relationship are obtained when the intimate relationship exists between the first account and the second account. The first virtual figure is combined with the feedback template corresponding to the intimate relationship, to determine the feedback information of the user emotion of the first account for the first social circle message. For example, the feedback template corresponding to the intimate relationship is preset, and the first virtual figure is combined with the feedback template to obtain the feedback information of the user emotion. For example, refer to operation 3485 and operation 3486 in some embodiments shown in FIG. 14. Details are not described herein again.

In some embodiments, a picture link of the feedback information is sent to the first client. For example, refer to operation 3489 in some embodiments shown in FIG. 14. Details are not described herein again.

In conclusion, according to the method provided in some embodiments, after the feedback request signaling is received, the feedback information of the user emotion for the first social circle message is determined based on the first virtual figure corresponding to the first account, so that user emotion feedback on a social circle message can be associated with a user account providing the feedback. This diversifies manners of feeding back a user emotion, enhances an effect of the user emotion feedback, and improves human-computer interaction efficiency.

The user emotion feedback method shown in the foregoing embodiments may be applied not only to a scenario in which a user feedback control is a “Like” control to display different like icons, but also to a user emotion feedback scenario such as “Favorite”, “Share”, and “Vote”. For example, when a user adds a social circle message to favorites, feedback information obtained based on a virtual figure corresponding to the user is displayed, to express that the user agrees on the social circle message or considers the social circle message useful. For another example, in a scenario in which a social circle message includes a vote, a user may express an attitude of the user through an emotion of a virtual figure corresponding to the user.

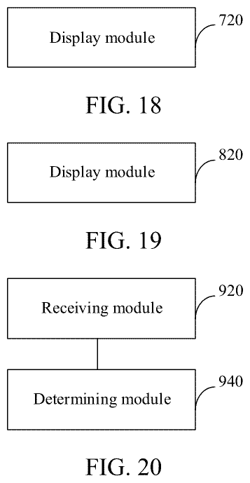

FIG. 18 is a block diagram of a structure of a user emotion feedback apparatus according to some embodiments. The apparatus is logged in with a first account, and the apparatus includes:
a display module 720, configured to display a first user interface, the first user
interface including a first social circle message posted by a second account, the display module 720 being further configured to display, through a first
virtual figure in response to a trigger operation on a user feedback control for the first social circle message, feedback information of a user emotion of the first account for the first social circle message,
the first virtual figure being a virtual figure corresponding to the first account, and the user feedback control being a control configured for providing emotion feedback on the first social circle message.

FIG. 19 is a block diagram of a structure of a user emotion feedback apparatus according to some embodiments. The apparatus is logged in with a second account, and the apparatus includes:
a display module 820, configured to display a second user interface, the second user interface including a first social circle message posted by the second account,
the display module 820 being configured to display, through a first virtual figure, feedback information of a user emotion of a first account for the first social circle message, and
the first virtual figure being a virtual figure corresponding to the first account.

FIG. 20 is a block diagram of a structure of a user emotion feedback apparatus according to some embodiments. The apparatus includes:
a receiving module 920, configured to receive feedback request signaling that is transmitted by a first client and that is of a user emotion for a first social circle message, the feedback request signaling including a first account, the first social circle message being a social circle message posted by a second account, and the first account being a user account logged in on the first client; and
a determining module 940, configured to determine, based on a first virtual figure, feedback information of the user emotion of the first account for the first social circle message,
the first virtual figure being a virtual figure corresponding to the first account.

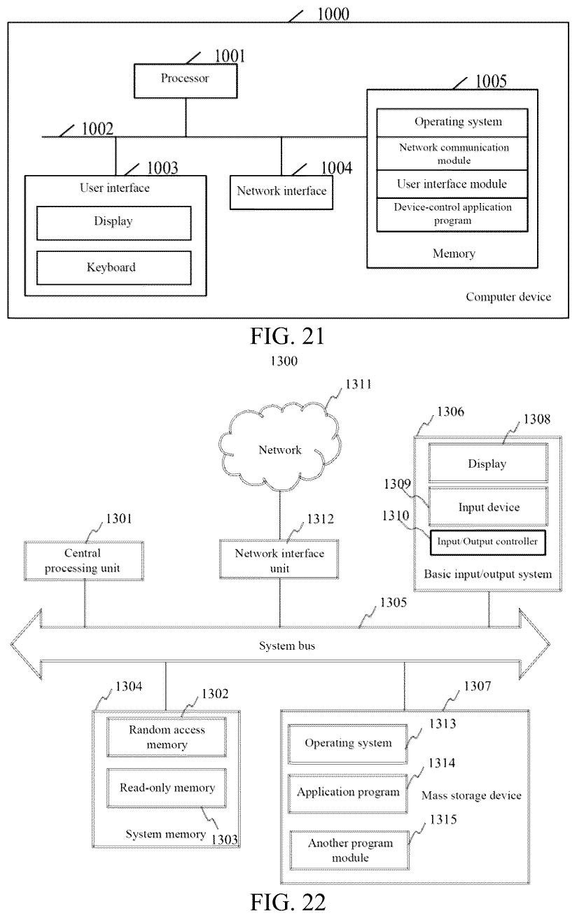

This application further provides a computer device (terminal). The computer device includes a processor and a memory, the memory having at least one instruction stored therein, and the at least one instruction being loaded and executed by the processor to implement the user emotion feedback method provided in the foregoing method embodiments. The computer device may be a computer device as shown in FIG. 21.

As shown in FIG. 21, the computer device 1000 may include: a processor 1001, a network interface 1004, and a memory 1005. In addition, the computer device 1000 may further include: a target user interface 1003 and at least one communication bus 1002. The communication bus 1002 is configured to implement connection communication between these components. The target user interface 1003 may include a display and a keyboard. In some embodiments, the target user interface 1003 may alternatively include a standard wired interface and a standard wireless interface. In some embodiments, the network interface 1004 may include a standard wired interface and a standard wireless interface (for example, a Wi-Fi interface). The memory 1005 may be a high-speed random access memory (RAM), or may be a non-volatile memory, for example, at least one magnetic disk memory. In some embodiments, the memory 1005 may alternatively be at least one storage apparatus far away from the processor 1001. As shown in FIG. 21, the memory 1005 used as a computer-readable storage medium may include an operating system, a network communication module, a target user interface module, and a device-control application program.

In the computer device 1000 shown in FIG. 21, the network interface 1004 may provide a network communication function. The target user interface 1003 may be configured to provide an input for a target user. The processor 1001 may be configured to invoke the device-control application program stored in the memory 1005 to implement a user emotion feedback method.

The computer device 1000 described in some embodiments can perform the descriptions of the user emotion feedback methods in embodiments corresponding to FIG. 8, FIG. 11 to FIG. 15, and FIG. 17. Details are not described herein again.

FIG. 22 is a schematic diagram of a structure of a server according to an exemplary embodiment. The server 1300 includes a central processing unit (CPU) 1301, a system memory 1304 including a random access memory (RAM) 1302 and a read-only memory (ROM) 1303, and a system bus 1305 connecting the system memory 1304 and the central processing unit 1301. The server 1300 further includes a input/output system (I/O system) 1306 assisting in transmitting information between components in the server, and a mass storage device 1307 configured to store an operating system 1313, an application program 1314, and another program module 1315.

The input/output system 1306 includes a display 1308 configured to display information and an input device 1309 such as a mouse or a keyboard configured to input information by a user. The display 1308 and the input device 1309 are both connected to the central processing unit 1301 by using an input/output controller 1310 connected to the system bus 1305. The input/output system 1306 may further include the input/output controller 1310 to be configured to receive and process inputs from a plurality of other devices such as a keyboard, a mouse, and an electronic stylus. Similarly, the input/output controller 1310 further provides an output to a display screen, a printer, or another type of output device.

The mass storage device 1307 is connected to the central processing unit 1301 by using a mass storage controller (not shown) connected to the system bus 1305. The mass storage device 1307 and a computer device-readable medium associated with the mass storage device 1307 provide non-volatile storage to the server 1300. The mass storage device 1307 may include a computer device-readable medium (not shown) such as a hard disk drive or a compact disc read-only memory (CD-ROM) drive.

In general, the computer device-readable medium may include a computer device storage medium and a communication medium. The computer device storage medium includes volatile and non-volatile media, and removable and non-removable media implemented by using any method or technology configured for storing information such as computer device-readable instructions, data structures, program modules, or other data. The computer device storage medium includes a RAM, a ROM, an erasable programmable read-only memory (EPROM), an electrically erasable programmable read-only memory (EEPROM), a CD-ROM, a digital versatile disc (DVD) or another optical storage, a magnetic cassette, a magnetic tape, a disk storage, or another magnetic storage device. Certainly, a person skilled in the art may know that the computer device storage medium is not limited to the foregoing several types. The system memory 1304 and the mass storage device 1307 may be collectively referred to as a memory.

According to some embodiments of the present disclosure, the server 1300 may alternatively be connected, over a network such as the Internet, to a remote computer device on the network and run. The server 1300 may be connected to a network 1311 by using a network interface unit 1312 connected to the system bus 1305, or may be connected to another type of network or a remote computer device system (not shown) by using the network interface unit 1312.

The memory further includes one or more programs. The one or more programs are stored in the memory. The central processing unit 1301 implements all or some operations of the user emotion feedback method by executing the one or more programs.

This application provides a computer-readable storage medium, the storage medium having at least one instruction stored thereon, and at least one instruction being loaded and executed by a processor to implement the user emotion feedback method provided in the foregoing method embodiments.

Some embodiments further provides a computer program product. When the computer program product runs on a computer, the computer is enabled to perform the user emotion feedback method provided in the foregoing embodiments.

The sequence numbers of the foregoing embodiments of this application are merely for description purpose but do not imply the preference among some embodiments.

A person of ordinary skill in the art may understand that all or some of the operations of embodiments may be implemented by hardware or program instructing related hardware. The program may be stored in a computer-readable storage medium. The storage medium may be a read-only memory, a magnetic disk, an optical disc, or the like.

The foregoing descriptions are merely optional embodiments of this application, but are not intended to limit this application. Any modification, equivalent replacement, or improvement made within the spirit and principle of this application shall fall within the protection scope of this application.

According to some embodiments, each module or unit may exist respectively or be combined into one or more units. Some units may be further split into multiple smaller function subunits, thereby implementing the same operations without affecting the technical effects of some embodiments. The units are divided based on logical functions. In actual applications, a function of one unit may be realized by multiple units, or functions of multiple units may be realized by one unit. In some embodiments, the apparatus may further include other units. These functions may also be realized cooperatively by the other units, and may be realized cooperatively by multiple units.

A person skilled in the art would understand that these “modules” could be implemented by hardware logic, a processor or processors executing computer software code, or a combination of both. The “modules” may also be implemented in software stored in a memory of a computer or a non-transitory computer-readable medium, where the instructions of each module are executable by a processor to thereby cause the processor to perform the respective operations of the corresponding module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A user emotion feedback method, performed by a computer device, the method comprising:
displaying, by a first client logged in with a first account, a first user interface comprising a first social circle message posted by a second account; and
displaying, by the first client, feedback information of a user emotion of the first account for the first social circle message through a first virtual figure, based on a trigger operation on a user feedback control for the first social circle message,
wherein the first virtual figure corresponds to the first account, and the user feedback control is configured to provide emotion feedback on the first social circle message.

2. The method according to claim 1,
wherein the displaying feedback information comprises:
displaying, by the first client, at least one candidate figure based on the first virtual figure and a first trigger operation on the user feedback control, wherein each of the at least one candidate figure is a first virtual figure with a different emotion; and
displaying, by the first client, a target figure of the at least one candidate figure as the feedback information of the user emotion of the first account for the first social circle message based on a second trigger operation on the target figure.

3. The method according to claim 2, wherein the displaying a target figure comprises:
transmitting, by the first client and based on the second trigger operation, first feedback request signaling of the user emotion to a server;
receiving, by the first client, first feedback response signaling returned by the server, the first feedback response signaling is configured to indicate whether user emotion feedback succeeds; and
displaying, by the first client, the target figure as the feedback information of the user emotion of the first account for the first social circle message based on the first feedback response signaling indicating that the user emotion feedback succeeds.

4. The method according to claim 2, wherein the candidate figure comprises at least one of the following:
a virtual figure associated with a happy emotion;
a virtual figure associated with a sad emotion;
a virtual figure associated with an angry emotion; or
a virtual figure associated with a fearful emotion.

5. The method according to claim 1, wherein the displaying feedback information comprises:
displaying, by the first client and based on a third trigger operation on the user feedback control, the first virtual figure having a first emotion as the feedback information in a case that the second account is online or an online state is set for the second account,
wherein the first emotion corresponds to the online state.

6. The method according to claim 5, wherein the displaying the first virtual figure comprises:
transmitting, by the first client and based on the third trigger operation on the user feedback control, second feedback request signaling of the user emotion to the server;
receiving, by the first client, second feedback response signaling returned by the server in a case that the second account is online or the online state is set for the second account, the second feedback response signaling comprising a first resource link of the first virtual figure and a second virtual figure that have the first emotion; and
downloading and displaying, by the first client and based on the first resource link, the first virtual figure and the second virtual figure as the feedback information of the user emotion,
wherein the second virtual figure corresponds to the second account.

7. The method according to claim 5, wherein
based on the online state being a happy state, the first emotion is associated with happy emotion;
based on the online state being a sad state, the first emotion is associated with encouraging emotion;
based on the online state being a leisure state, the first emotion is associated with relaxed emotion; and
based on the online state being a hardworking state, the first emotion is associated with focused emotion.

8. The method according to claim 1, wherein the displaying feedback information comprises:
displaying, by the first client and based on a fourth trigger operation on the user feedback control, the first virtual figure having a second emotion as the feedback information, in a case that an intimate relationship exists between the first account and the second account,
wherein the second emotion corresponds to the intimate relationship.

9. The method according to claim 8, wherein the displaying the first virtual figure comprises:
transmitting, by the first client and based on the fourth trigger operation on the user feedback control, third feedback request signaling of the user emotion to the server;
receiving, by the first client, third feedback response signaling returned by the server in a case that the intimate relationship exists between the first account and the second account, the third feedback response signaling comprising a second resource link of the first virtual figure and the second virtual figure that have the second emotion; and
downloading and displaying, by the first client and based on the second resource link, the first virtual figure and the second virtual figure that have the second emotion as the feedback information,
wherein the second virtual figure corresponds to the second account.

10. The method according to claim 8, wherein
based on the intimate relationship being a couple relationship, the second emotion is associated with loving emotion;
based on the intimate relationship being a brother relationship, the second emotion is associated with excited emotion;
based on the intimate relationship being a sister relationship, the second emotion is associated with shy emotion; and
based on the intimate relationship being a friend relationship, the second emotion is associated with pleasant emotion.

11. The method according to claim 1, further comprising:
displaying, by a second client logged in with the second account, a second user interface comprising the first social circle message posted by the second account; and
displaying, by the second client, the feedback information of a user emotion of a first account for the first social circle message through a first virtual figure.

12. The method according to claim 11, wherein the displaying the feedback information comprises:
displaying, by the second client, a target figure in a scrolling manner as the feedback information, the target figure being a combination of the first virtual figure having a target emotion with an emotion sticker having the target emotion.

13. The method according to claim 11, wherein the displaying the feedback information comprises:
displaying, by the second client, the first virtual figure and a second virtual figure that have a first emotion as the feedback information in a case that the second account is online or an online state is set for the second account,
wherein the first emotion corresponds to the online state, and the second virtual figure is a virtual figure corresponding to the second account.

14. The method according to claim 11, wherein the displaying the feedback information comprises:
displaying, by the second client, the first virtual figure and the second virtual figure that have a second emotion as the feedback information in a case that an intimate relationship exists between the first account and the second account,
wherein the second emotion corresponds to the intimate relationship, and the second virtual figure corresponds to the second account.

15. A user emotion feedback apparatus, comprising:
at least one memory configured to store program code; and
at least one processor configured to read the program code and operate as instructed by the program code, the program code comprising:
interface code configured to cause at least one of the at least one processor to display, by a first client logged in with a first account, a first user interface comprising a first social circle message posted by a second account; and
feedback code configured to cause at least one of the at least one processor to display, by the first client, feedback information of a user emotion of the first account for the first social circle message through a first virtual figure, based on a trigger operation on a user feedback control for the first social circle message,
wherein the first virtual figure corresponds to the first account, and the user feedback control is configured to provide emotion feedback on the first social circle message.

16. The apparatus according to claim 15,
wherein the feedback code is further configured to cause at least one of the at least one processor to:
display, by the first client, at least one candidate figure based on the first virtual figure and a first trigger operation on the user feedback control, wherein each of the at least one candidate figure is a first virtual figure with a different emotion; and
display, by the first client, a target figure of the at least one candidate figure as the feedback information of the user emotion of the first account for the first social circle message based on a second trigger operation on the target figure.

17. The apparatus according to claim 16, wherein the feedback code is further configured to cause at least one of the at least one processor to:
transmit, by the first client and based on the second trigger operation, first feedback request signaling of the user emotion to a server;
receive, by the first client, first feedback response signaling returned by the server, the first feedback response signaling is configured to indicate whether user emotion feedback succeeds; and
display, by the first client, the target figure as the feedback information of the user emotion of the first account for the first social circle message based on the first feedback response signaling indicating that the user emotion feedback succeeds.

18. The apparatus according to claim 16, wherein the candidate figure comprises at least one of the following:
a virtual figure associated with a happy emotion;
a virtual figure associated with a sad emotion;
a virtual figure associated with an angry emotion; or
a virtual figure associated with a fearful emotion.

19. The apparatus according to claim 15, wherein the feedback code is further configured to cause at least one of the at least one processor to:
display, by the first client and based on a third trigger operation on the user feedback control, the first virtual figure having a first emotion as the feedback information in a case that the second account is online or an online state is set for the second account,
wherein the first emotion corresponds to the online state.

20. A non-transitory computer-readable storage medium, storing computer code which, when executed by at least one processor, causes the at least one processor to at least:
display, by a first client logged in with a first account, a first user interface comprising a first social circle message posted by a second account; and
display, by the first client, feedback information of a user emotion of the first account for the first social circle message through a first virtual figure, based on a trigger operation on a user feedback control for the first social circle message,
wherein the first virtual figure corresponds to the first account, and the user feedback control is configured to provide emotion feedback on the first social circle message.
